(19) United States
(12) Patent Application Publication
(10) Pub. No.: US 2018/0302354 A1
(43) Pub. Date: Oct. 18, 2018

(54) GROUP OUTING PROVISION SYSTEM AND METHOD THEREOF

(71) Applicant: CHESHIRE ELECTRIC COMPANY, LLC, TAOYUAN COUNTY (TW)

(72) Inventor: HUI-LING LEE, TAOYUAN CITY (TW)

(21) Appl. No.: 15/490,010

(22) Filed: Apr. 18, 2017

(51) Int. Cl. H04L 12/58; H04L 29/08

(52) U.S. Cl. CPC H04L 51/046; H04L 67/10; H04L 67/22; H04L 67/18; H04L 67/306

(57) ABSTRACT

A group outing provision system applicable to a plurality of mobile devices executing a group outing application, the group outing provision system including: an account management server, an itinerary management server, a route planning server and a group management server. The account management server enables each of the plurality of mobile devices to sign up for or sign in with a representative account. The itinerary management server enables the representative account to add or join at least one itinerary. The route planning server enables the representative account to input route information when adding the at least one itinerary or to acquire the route information when joining the at least one itinerary. The group management server enables the representative account to generate a group when adding the at least one itinerary or to join the group when joining the at least one itinerary.

### BACKGROUND

### 1. Technical Field

The present invention generally relates to a trip provision/management system and a method thereof and, more particularly, to a group outing provision system and a method thereof.

### 2. Description of Related Art

Group outings for jogging, biking, etc. are very popular. For those who are keen on group outings, a group outing platform is required, such that the group members can select a desired itinerary to join, or create and manage an itinerary or event of their own so that the other group members can join in. Therefore, there is a need in the art for providing a group outing provision system and a method thereof.

### SUMMARY

The present invention provides a group outing provision system and a method thereof, allowing persons who are keen on group outings to have a multifunctional group outing platform that is capable of creating, joining, planning, coordinating, and monitoring an itinerary and group members thereof, such that the group members can select a desired itinerary to join, or provide and manage an itinerary having at least one event of their own so that the other group members can join in. During the course of an itinerary, in order to prevent harassment, each of the mobile devices of the group members is represented only by a representative account, and the itinerary itself is time-sensitive. As the itinerary comes to an end, the group associated with the itinerary is dismissed. Furthermore, to ensure the safety of the group members, it is necessary for the whereabouts of each of the group members to be known. Thanks to the prevalence of modern smart devices and the ability to acquire the exact coordinates of locations using global positioning systems (GPS's) or assisted global positioning systems (AGPS's), the group associated with the itinerary can track all the group members using positioning systems, inform all the group members of the locations of one another, and enable the group members to communicate and issue an alert regularly when some of the group members stray from meeting points.

One embodiment of the present invention provides a group outing provision system applicable to a plurality of mobile devices executing a group outing application, the group outing provision system including: an account management server configured to enable each of the plurality of mobile devices to sign up for or sign in with a representative account; an itinerary management server configured to enable the representative account to add or join at least one itinerary; a route planning server configured to enable the representative account to input route information when adding the at least one itinerary or to acquire the route information when joining the at least one itinerary; and a group management server configured to enable the representative account to generate a group when adding the at least one itinerary or to join the group when joining the at least one itinerary.

Another embodiment of the present invention provides a group outing provision method applicable to a group outing provision system, the group outing provision method including: Step S101: signing up for or signing in with a representative account; Step S103: adding or joining at least one itinerary; Step S105: inputting route information when adding the at least one itinerary or acquiring the route information when joining the at least one itinerary; Step S107: generating a group when adding the at least one itinerary or joining the group when joining the at least one itinerary.

In order to further understand the techniques, means and effects of the present invention, the following detailed descriptions and appended drawings are hereby referred to, such that, and through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain the principles of the present invention.

FIG. 1 is a schematic diagram of a group outing provision system according to one embodiment of the present invention;

FIG. 2 is a flowchart of a group outing provision method according to one embodiment of the present invention;

FIG. 3 is a flowchart of a method for signing up for or signing in with a representative account according to one embodiment of the present invention;

FIG. 4 is a flowchart of a method for warning that a mobile device is moving away from a group according to one embodiment of the present invention.

### DESCRIPTION OF THE EXEMPLARY EMBODIMENTS

The detailed description set forth below in connection with the appended drawings is intended as a description of certain embodiments of the present invention, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present invention.

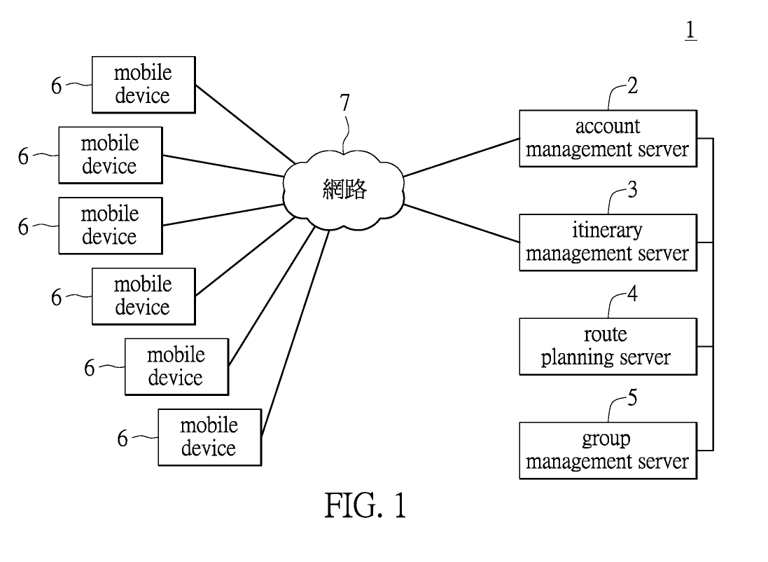

FIG. 1 is a schematic diagram of a group outing provision system according to one embodiment of the present invention. As shown in FIG. 1, the group outing provision system 1 is applicable to a plurality of mobile devices 6 executing a group outing application. The group outing provision system 1 includes an account management server 2, an itinerary management server 3, a route planning server 4 and a group management server 5. The itinerary management server 3 is connected to the account management server 2. The route planning server 4 is connected to the account management server 2 and the itinerary management server 3. The group management server 5 is connected to the account management server 2, the itinerary management server 3 and the route planning server 4. The plurality of mobile devices 6 is connected to the account management server 2, the itinerary management server 3, the route planning server 4 and the group management server 5 through a network 7.

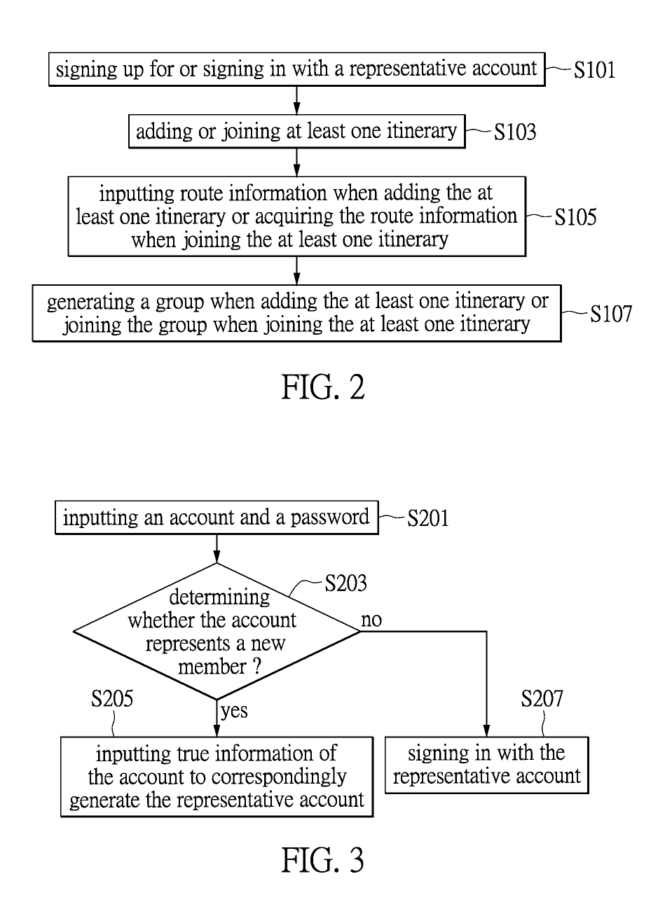

FIG. 2 is a flowchart of a group outing provision method according to one embodiment of the present invention. As shown in FIG. 2, the group outing provision method is applicable to the group outing provision system in FIG. 1. The group outing provision method includes the steps as follows. In Step S101, a representative account is signed up for or signed in with. In Step S103, at least one itinerary is added or joined in. In Step S105, route information is inputted when adding the at least one itinerary or the route information is acquired when joining the at least one itinerary. In Step S107, a group is generated when adding the at least one itinerary or the group is joined when joining the at least one itinerary.

FIG. 3 is a flowchart of a method for signing up for or signing in with a representative account in Step S101 according to one embodiment of the present invention. The account management server 2 is configured to enable each of the plurality of mobile devices 6 to sign up for or sign in with the representative account by the following steps. In Step S201, an account and a password are inputted. In Step S203, whether the account represents a new member is determined. The method proceeds to Step S205 if the account represents a new member or the method proceeds to Step S207 if the account does not represent a new member. In Step S205, true information of the account is inputted to correspondingly generate the representative account. In Step S207, the representative account is signed in.

More particularly, in Step S201, each of the plurality of mobile devices 6 executes the group outing application and each of the plurality of mobile devices 6 is connected to the account management server 2. The account management server 2 sends back a login interface for inputting an account and a password on a display of each of the plurality of mobile devices 6 such that the user inputs the account and the password on the display.

In Step S203, whether the account represents a new member is determined. The method proceeds to Step S205 if the account represents a new member or the method proceeds to Step S207 if the account does not represent a new member. One of the mobile devices 6 sends the account back to the account management server 2 when the user inputs the account on the display, such that the account management server 2 determines whether the account is valid. If the account management server 2 determines that the account is not valid, the account management server 2 sends back a login interface for signing up on the display of the mobile device 6, and the method proceeds to Step S205. If the account management server 2 determines that the account is valid, the method proceeds to Step S207.

In Step S205, true information of the account is inputted to correspondingly generate the representative account. The user inputs the true information in the interface for signing up on the display of one of the mobile devices 6 to sign up as a member and generate a representative account. The true information includes a Chinese name, an English name, an ID number, a passport number, a birth date, an address, a postal code, emergency contact, and so on. The representative account is inputted by the user or generated by the account management server.

In Step S207: the representative account is signed in. The user inputs the account and the password on the display of one of the mobile devices 6 to sign in to the account management server 2 with the representative account.

Accordingly, the representative account is used instead of the true information so as to protect personal privacy and prevent the personal information from being leaked.

In Step S103, at least one itinerary is added or joined in. More particularly, the itinerary management server 3 is configured to enable the representative account to add or join at least one itinerary. After the user signs in to the account management server 2 with the representative account, the mobile device 6 is connected to the itinerary management server 3 such that the itinerary management server 3 sends back an interface for adding or joining the at least one itinerary on a display of each of the plurality of mobile devices 6. In the meantime, the itinerary management server 3 recommends other itineraries to the representative account. When the representative account adds the at least one itinerary, the representative account determines whether to grant authorization to manage a group that is generated based on the at least one itinerary. The authorization allows the representative account to determine whether to allow other representative accounts to join the at least one itinerary so as to manage the group and prevent unintended members from joining. In the meantime, the itinerary management server 3 generates a barcode or a Quick Response code (i.e., QR code) related to the at least one itinerary to enable the other mobile devices 6 corresponding to the other representative accounts to scan the barcode and join the at least one itinerary. The barcode can be a one-dimensional barcode or a two-dimensional barcode.

In Step S105, the route information is inputted when adding the at least one itinerary or the route information is acquired when joining the at least one itinerary. More particularly, the route planning server 4 is configured to enable the representative account to input route information when adding the at least one itinerary or to acquire the route information when joining the at least one itinerary. The route information is required when the representative account adds the at least one itinerary. The route planning server 4 provides the representative account with the route information so as to input the route information. The route information includes the name information, the routing information, the time information, the scenic spot recommendation information and the store and shop recommendation information of the at least one itinerary. The name information includes the theme and the objective of the at least one itinerary. The routing information includes the starting point, the ending point, the paths, the directions, and so on. The time information includes the starting time, the ending time, the driving time, and so on. The scenic spot recommendation information includes information related to scenic spots along the paths, recommended scenic spots, evaluation of scenic spots, and so on. The store and shop recommendation information includes information related to stores along the paths, recommended stores, evaluation of stores, and so on. The scenic spot recommendation information and the store and shop recommendation information can be inputted by the representative account or provided by the route planning server 4.

In Step S107, a group is generated when adding the at least one itinerary or the group is joined when joining the at least one itinerary. More particularly, the group management server 5 is configured to enable the representative account to generate a group when adding the at least one itinerary or to join the group when joining the at least one itinerary. The representative account generates a group when adding the at least one itinerary. The at least one itinerary has a time span. The group management server 5 provides the group and displays information of the group on the display of each of the plurality of mobile devices 6 in the group in the time span. The group management server 5 provides the group with a chatroom to broadcast announcement information and transceive message information in the time span. The announcement information includes meeting time information, meeting location information, surrounding situation information, precaution information, abnormality warning information and alert notification information. The message information includes text information, video information and audio information. In the time span, the representative account broadcasts the announcement information to the group in the chatroom and transceives the message information in the group. The other representative accounts in the group can transceive the message information to/from the group in the chatroom in the time span. The surrounding situation information includes traffic information. The precaution information includes driving safety information and personal safety information. The alert notification information includes water safety information. The text information, the video information and the audio information are interactive messages in the chatroom. The examples of the announcement information and the message information are only exemplary and are not intended to limit the scope of the present invention. The group management server 5 provides the group with an emergency link. An icon corresponding to the emergency link is displayed on the display of each of the plurality of mobile devices 6 such that each user in the group may call for emergency assistance. The group management server 5 provides the group with map information in the time span to display information of each of the plurality of mobile devices 6 in the group on the display of each of the plurality of mobile devices 6 in the group. The map information includes location name information, routing information, time information, scenic spot recommendation information and store and shop recommendation information of the at least one itinerary, and the representative account, position information, movement information, relative distance information and relative time information of each of the plurality of mobile devices 6 in the group.

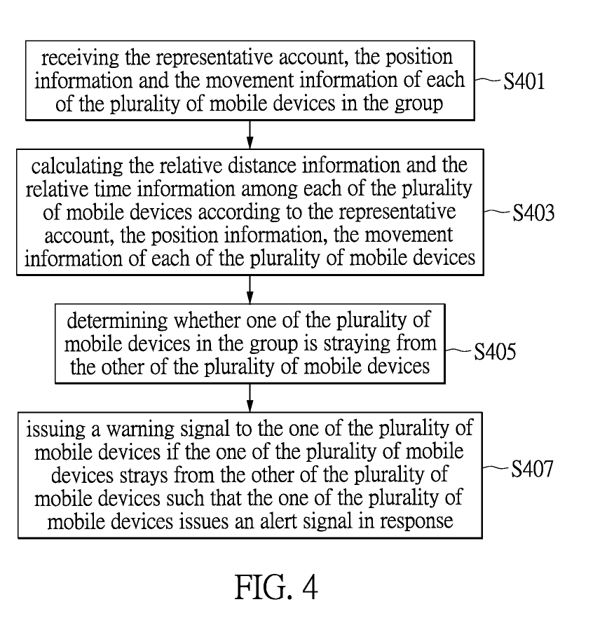

FIG. 4 is a flowchart of a method for warning a mobile device away from a group according to one embodiment of the present invention. The group management server 5 determines whether one of the plurality of mobile devices 6 in the group is straying from the other of the plurality of mobile devices 6. The group management server 5 transmits a warning signal to the one of the plurality of mobile devices 6 if the one of the plurality of mobile devices 6 strays from the other of the plurality of mobile devices 6 such that the one of the plurality of mobile devices 6 issues an alert signal in response. The alert signal includes an audio signal, a visual signal and/or a vibration signal. The group management server 5 determines whether one of the plurality of mobile devices 6 in the group is straying from the other of the plurality of mobile devices 6 by the following steps. In Step S401, the representative account, the position information and the movement information of each of the plurality of mobile devices 6 in the group are received. In Step S403, the relative distance information and the relative time information among each of the plurality of mobile devices 6 in the group are calculated according to the representative account, the position information, and the movement information of each of the plurality of mobile devices 6 in the group. In Step S405, whether one of the plurality of mobile devices 6 in the group is straying from the other of the plurality of mobile devices 6 in the group is determined. In Step S407, a warning signal is issued to the one of the plurality of mobile devices 6 in the group if the one of the plurality of mobile devices 6 strays from the other of the plurality of mobile devices 6 such that the one of the plurality of mobile devices 6 issues an alert signal in response.

In Step S401, the representative account, the position information and the movement information of each of the plurality of mobile devices 6 in the group are received. More particularly, the group management server 5 receives the representative account, the position information and the movement information of each of the plurality of mobile devices 6 in the group so as to calculate the relative distance information and the relative time information among each of the plurality of mobile devices 6 in the group.

In Step S403, the relative distance information and the relative time information among each of the plurality of mobile devices 6 in the group are calculated according to the representative account, the position information, and the movement information of each of the plurality of mobile devices 6 in the group. More particularly, after receiving the representative account, the position information and the movement information of each of the plurality of mobile devices 6 in the group, the group management server 5 calculates the relative distance information and the relative time information among each of the plurality of mobile devices 6 in the group according to the representative account, the position information and the movement information of each of the plurality of mobile devices 6 in the group. The map information is displayed on the display of each of the plurality of mobile devices 6 in the group to show the relative distance information and the relative time information among each of the plurality of mobile devices 6 in the group. Accordingly, the user may know the distance between the user and the other users. For example, when the users are to meet at a certain place, the user using one of the plurality of mobile devices 6 may know whether he/she is moving away from or closing in to the meeting location and/or the moving direction of the other users.

In Step S405, whether one of the plurality of mobile devices 6 in the group is straying from the other of the plurality of mobile devices 6 in the group is determined. More particularly, the group management server 5 determines whether one of the plurality of mobile devices 6 in the group is straying from the other of the plurality of mobile devices 6. The representative account that adds the at least one itinerary can determine a meeting location such that the group management server 5 can determine whether each of the plurality of mobile devices 6 in the group is moving towards the meeting location according to the meeting location, the relative distance information and the relative time information among each of the plurality of mobile devices 6 in the group.

In Step S407, a warning signal is issued to the one of the plurality of mobile devices 6 in the group if the one of the plurality of mobile devices 6 is straying from the other of the plurality of mobile devices 6 such that the one of the plurality of mobile devices 6 issues an alert signal in response. More particularly, when the group management server 5 determines that one of the plurality of mobile devices 6 in the group is moving away from the meeting location or the moving direction of the other of the plurality of mobile devices 6 in the group, the group management server 5 issues a warning signal to the one of the plurality of mobile devices 6 that is straying to inform the one of the mobile devices 6 that he/she is moving away from the others. After receiving the warning signal, the one of the mobile devices 6 that is straying issues an alert signal such as a ring, a flash, a vibration of the mobile device 6, and so on. Moreover, the group management server 5 also issues a warning signal to the representative account adding the group to inform that one of the plurality of the mobile devices 6 in the group is straying from the group.

Moreover, the group outing provision system according to the present invention also enables the user using the group outing application to provide the emergency contact with information related to the outing location, the itinerary, traffic and types of vehicles, and so on. The information related to traffic and types of vehicles includes the vehicle identification number, departure/arrival time, driving time, and so on.

In sum, the group outing provision system and the method thereof according to the present invention provides group management, privacy protection, real-time interactions, alert announcements, route planning, personnel positioning, safety measures, scenic spot recommendations, store and shop recommendations, and so on, to achieve the creation, joining, planning, coordination, and monitoring of itineraries and group members thereof. The mobile devices can be accessed during the group outing to provide the group outing information.

The above-mentioned descriptions represent merely the exemplary embodiment of the present invention, without any intention to limit the scope of the present invention thereto. Various equivalent changes, alterations or modifications based on the claims of present invention are all consequently viewed as being embraced by the scope of the present invention.

What is claimed is:

1. A group outing provision system applicable to a plurality of mobile devices executing a group outing application, said group outing provision system comprising:
an account management server configured to enable each of said plurality of mobile devices to sign up for or sign in with a representative account;
an itinerary management server configured to enable said representative account to add or join at least one itinerary;
a route planning server configured to enable said representative account to input route information when adding said at least one itinerary or to acquire said route information when joining said at least one itinerary; and
a group management server configured to enable said representative account to generate a group when adding said at least one itinerary or to join said group when joining said at least one itinerary.

2. The group outing provision system of claim 1, wherein each of said plurality of mobile devices signs up for or signs in with said representative account by the steps including:
a. inputting an account and a password;
b. determining whether said account represents a new member;
c. inputting true information of said account to correspondingly generate said representative account if said account represents a new member; and
d. signing in with said representative account if said account does not represent a new member.

3. The group outing provision system of claim 1, wherein said representative account grants authorization to manage said group when adding said at least one itinerary.

4. The group outing provision system of claim 3, wherein said authorization determines whether to allow other representative accounts to join said at least one itinerary.

5. The group outing provision system of claim 1, wherein said itinerary management server recommends to said representative account other itineraries when said representative account adds or joins said at least one itinerary.

6. The group outing provision system of claim 1, wherein said itinerary management server generates a barcode when said representative account adds said at least one itinerary.

7. The group outing provision system of claim 1, wherein a mobile device corresponding to said representative account scans a barcode to join said at least one itinerary.

8. The group outing provision system of claim 6, wherein said barcode is a one-dimensional barcode or a two-dimensional barcode.

9. The group outing provision system of claim 1, wherein said route information includes name information, routing information, time information, scenic spot recommendation information and/or store and shop recommendation information of said at least one itinerary.

10. The group outing provision system of claim 1, wherein said at least one itinerary has a time span.

11. The group outing provision system of claim 10, wherein said group is generated in said time span and information of said group is displayed on a display of each of said plurality of mobile devices in said group.

12. The group outing provision system of claim 11, wherein said group management server provides said group with a chatroom to broadcast announcement information and transceive message information in said time span.

13. The group outing provision system of claim 12, wherein said announcement information includes meeting time information, meeting location information, surrounding situation information, precaution information, abnormality warning information and/or alert notification information.

14. The group outing provision system of claim 12, wherein said message information includes text information, video information and/or audio information.

15. The group outing provision system of claim 12, wherein said group management server further provides said group with an emergency link in said time span, and an icon corresponding to the emergency link is displayed on said display of each of said plurality of mobile devices.

16. The group outing provision system of claim 10, wherein said group management server provides said group with map information in said time span to display information of each of said plurality of mobile devices in said group on said display of each of said plurality of mobile devices in said group.

17. The group outing provision system of claim 16, wherein said map information includes location name information, routing information, time information, scenic spot recommendation information and/or store and shop recommendation information of said at least one itinerary, and said representative account, position information, movement information, relative distance information and/or relative time information of each of said plurality of mobile devices in said group.

18. The group outing provision system of claim 17, wherein said group management server determines whether one of said plurality of mobile devices in said group is straying from the other of said plurality of mobile devices, and said group management server transmits a warning signal to said one of said plurality of mobile devices if said one of said plurality of mobile devices is straying from the other of said plurality of mobile devices such that said one of said plurality of mobile devices issues an alert signal in response.

19. The group outing provision system of claim 18, wherein said alert signal includes an audio signal, a visual signal and/or a vibration signal.

20. The group outing provision system of claim 17, wherein said group management server determines whether one of said plurality of mobile devices in said group is straying from the other of said plurality of mobile devices by the steps including:
a. receiving said representative account, said position information and said movement information of each of said plurality of mobile devices in said group;
b. calculating said relative distance information and said relative time information among each of said plurality of mobile devices in said group according to said representative account, said position information, said movement information of each of said plurality of mobile devices in said group;
c. determining whether one of said plurality of mobile devices in said group is straying from the other of said plurality of mobile devices in said group; and
d. issuing a warning signal to said one of said plurality of mobile devices in said group if said one of said plurality of mobile devices is straying from the other of said plurality of mobile devices such that said one of said plurality of mobile devices issues an alert signal in response, said alert signal including an audio signal, a visual signal and/or a vibration signal.

21. A group outing provision method applicable to the group outing provision system of claim 1, said group outing provision method comprising the steps of:
a. signing up for or signing in with said representative account;
b. adding or joining said at least one itinerary;
c. inputting said route information when adding said at least one itinerary or acquiring said route information when joining said at least one itinerary; and
d. generating said group when adding said at least one itinerary or joining said group when joining said at least one itinerary.

22. The group outing provision method of claim 21, wherein the step of signing up for or signing in with said representative account includes the steps of:
a-1. inputting an account and a password;
a-2 determining whether said account represents a new member;
a-3. inputting true information of said account to correspondingly generate said representative account if said account represents a new member; and
a-4. signing in with said representative account if said account does not represent a new member.

23. The group outing provision method of claim 21, wherein said route information includes name information, routing information, time information, scenic spot recommendation information and store and shop recommendation information of said at least one itinerary.

24. The group outing provision method of claim 21, wherein said at least one itinerary has a time span.

25. The group outing provision method of claim 24, wherein said group is generated in said time span and information of said group is displayed on a display of each of said plurality of mobile devices in said group.

26. The group outing provision method of claim 25, wherein map information is displayed on said display of each of said plurality of mobile devices in said group in said time span.

27. The group outing provision method of claim 26, wherein said map information includes location name information, routing information, time information, scenic spot recommendation information and/or store and shop recommendation information of said at least one itinerary, and said representative account, position information, movement information, relative distance information and/or relative time information of each of said plurality of mobile devices in said group.

28. The group outing provision method of claim 27, wherein one of said plurality of mobile devices in said group receives a warning signal and issues an alert signal in response when said one of said plurality of mobile devices in said group strays from the other of said plurality of mobile devices, said alert signal including an audio signal, a visual signal and/or a vibration signal.

29. The group outing provision method of claim 26, wherein said group enters a chatroom to broadcast announcement information and transceive message information in said time span.

30. The group outing provision method of claim 29, wherein said announcement information includes meeting time information, meeting location information, surrounding situation information, precaution information, abnormality warning information and/or alert notification information.

31. The group outing provision method of claim 29, wherein said message information includes text information, video information and/or audio information.
